(19) United States
(12) Patent Application Publication
(10) Pub. No.: US 2024/0064650 A1
(43) Pub. Date: Feb. 22, 2024

(54) TERMINAL, SYSTEM AND COMMUNICATION METHOD

(71) Applicant: NTT DOCOMO, INC., Tokyo (JP)

(72) Inventors: Yuta Oguma, Chiyoda-ku, Tokyo (JP); Ryu Kitagawa, Chiyoda-ku, Tokyo (JP)

(73) Assignee: NTT DOCOMO, INC., Tokyo (JP)

(21) Appl. No.: 18/260,996

(22) PCT Filed: Jan. 14, 2021
(86) PCT No.: PCT/JP2021/001137

§ 371 Date: Jul. 11, 2023

(51) Int. Cl. H04W 52/14; H04W 8/24

(52) U.S. Cl. CPC H04W 52/146; H04W 8/24

(57) ABSTRACT

A terminal is disclosed including a control section that generates Capability information including a Power Class of the terminal; and a transmission section that transmits the Capability information, wherein Max TRP (Total Radiated Power) and Max EIRP (Equivalent Isotropic Radiated Power) are specified for each of the Power Classes, and in at least one of the Power Classes, each of a specified value of Max EIRP for a first band and a specified value of Max EIRP for a second band is defined separately in Inter-band CA (Carrier Aggregation) using two bands. In other aspects, a system and a communication method are also disclosed.

### TECHNICAL FIELD

The present disclosure relates to a terminal, a system, and a communication method.

### BACKGROUND ART

In a universal mobile telecommunication system (UMTS) network, successor systems of long term evolution (LTE) have been studied (Non Patent Literature (hereinafter, referred to as NPL) 1). The successor systems of LTE include, for example, systems called LTE-advanced (LTE-A), future radio access (FRA), 5th generation mobile communication system (5G), 5G plus (5G+), new radio access technology (New-RAT; NR), and the like.

3GPP specifies the maximum transmit power per power class (hereinafter, sometimes abbreviated as “PC”) in each of Sub6 (LTE/NR Frequency Range (FR) 1), which is a frequency of 6 GHz or lower including the 3.7 GHz band and 4.5 GHz band, and a millimeter wave band (NR FR 2) such as the 28 GHz band and 38 GHz band.

Note that 3GPP specifies n257 (uplink: 26500 MHz-29500 MHz, downlink: 26500 MHz-29500 MHz), n258 (uplink: 24250 MHz-27500 MHz, downlink: 24250 MHz-27500 MHz), n261 (uplink: 27500 MHz-28350 MHz, downlink: 27500 MHz-28350 MHz) as operating bands belonging to the 28 GHz band, and n259 (uplink: 39500 MHz-43500 MHz, downlink: 39500 MHz-43500 MHz), n260 (uplink: 37000 MHz-40000 MHz, downlink: 37000 MHz-40000 MHz) as operating bands belonging to the 38 GHz band (see NPL 1).

Each terminal is configured with a power class before shipped from the factory and controls the transmit power so as to meet the transmit power specification of the power class at the time of transmitting a radio signal. In addition, each terminal indicates information indicating the UE capability including the power class (hereinafter, referred to as “capability information”) to a base station at the start of communication.

3GPP specifies power classes PC1 to PC4 for Sub6 and power classes PC1 to PC4 for FR2. PC1 in FR2 is for fixed wireless communication, and PC2 in FR2 is for automotive.

Omni-antennas, which has no directivity, are used in Sub6, and each power class is specified by total radiated power (TRP). The TRP is the total power radiated into space.

In FR2, power is radiated by array antennas forming directivity (beamforming), and four items of max TRP, max peak equivalent isotropic radiated power (EIRP), min peak EIRP, and spherical coverage EIRP are specified for each power class in each of the frequency bands (see NPL 1). Note that the EIRP is a combined value of the transmit power and antenna gain.

In a case of PC3 in FR2 (28 GHz band), for example, Max TRP ≤23 dBm, Max peak EIRP ≤43 dBm, Min peak EIRP ≥22.4 dBm, Spherical coverage EIRP ≥(11.5 dBm, 50%-tile CDF) (see FIG. 3). Terminals in PC3 control the transmit power so as to meet all of these specifications of the four items at the time of transmitting radio signals.

The spherical coverage EIRP is a specification of spatial power (EIRP) distribution around a terminal, which contributes to the connectivity between the terminal and a base station, and is specified by %-tile from the upper limit of the cumulative distribution function (CDF). For example, the expression “Spherical coverage EIRP ≥(25.0 dBm, 20%-tile CDF)”, which is for PC4, indicates that the EIRP is 25 dBm or lower at 20% of the CDF points, i.e., it exceeds 25 dBm at 80% of all measurement points in the space.

### CITATION LIST

Non Patent Literature
NPL 1
3GPP TS 38.101-2 V16.4.0 (2020-06)

### SUMMARY OF INVENTION

### Technical Problem

In inter-band carrier aggregation (CA) in FR2, 3GPP has so far specified the total power of max TRP for each CC, the total power of max peak EIRP for each CC, the total power of min peak EIRP for each CC, and the total power of spherical coverage EIRP for each CC based on the assumption that radio waves are radiated simultaneously in the same direction in consecutive component carriers (CCs) in the same band.

The inter-band CA in FR2, however, may include a case where radio waves are radiated simultaneously in a plurality of directions from the same or different antenna panels in a plurality of CCs. Note that, even in a case where radio waves are radiated from a single antenna panel in the same direction in different frequency bands, the directivity of beams possibly varies depending on frequency characteristics due to the difference in frequency bands.

In addition, spatial directivity needs to be taken into account in calculating the EIRP or TRP.

Thus, for the inter-band CA in FR2, it is preferable to newly determine the specification value of each of the items such as max peak EIRP (hereinafter, referred to as a “radiated power specification value”) taking into account the directions in which radio waves are radiated. It is further preferable to take into account the relation between the operating bands of two CCs composing the inter-band CA to determine the radiated power specification values in the inter-band CA in FR2.

One of the objectives of the present disclosure is to propose a method of determining the radiated power specification values in the inter-band CA in FR2 taking into account the relation between the operating bands of two CCs.

### Solution to Problem

A terminal according to one aspect of the present disclosure includes: a control section that generates capability information including a power class of the terminal; and a transmission section that transmits the capability information, wherein, max total radiated power (TRP), max peak equivalent isotropic radiated power (EIRP), min peak EIRP, and spherical coverage EIRP are specified for the power class, and a method of determining a specification value of at least one of the max peak EIRP and the max TRP in inter-band carrier aggregation (CA) depends on a relation between operating bands of two component carriers (CCs) composing the inter-band CA.

A system according to one aspect of the present disclosure includes: a terminal that generates capability information including a power class of the terminal and transmits the capability information; and a base station that receives the capability information, wherein, max total radiated power (TRP), max peak equivalent isotropic radiated power (EIRP), min peak EIRP, and spherical coverage EIRP are specified for the power class, and a method of determining a specification value of at least one of the max peak EIRP and the max TRP in inter-band carrier aggregation (CA) depends on a relation between operating bands of two component carriers (CCs) composing the inter-band CA.

A communication method according to one aspect of the present disclosure includes: generating, by a terminal, capability information including a power class of the terminal; and transmitting, by the terminal, the capability information, wherein, max total radiated power (TRP), max peak equivalent isotropic radiated power (EIRP), min peak EIRP, and spherical coverage EIRP are specified for the power class, and a method of determining a specification value of at least one of the max peak EIRP and the max TRP in inter-band carrier aggregation (CA) depends on a relation between operating bands of two component carriers (CCs) composing the inter-band CA.

### Advantageous Effects of Invention

According to the present disclosure, it is possible to determine radiated power specification values in inter-band CA in FR2 taking into account a relation between operating bands of two CCs.

### BRIEF DESCRIPTION OF DRAWINGS

FIG. 1 This figure is a block diagram illustrating an exemplary configuration of a base station.

FIG. 2 This figure is a block diagram illustrating an exemplary configuration of a terminal.

FIG. 3 This figure illustrates specification values of items for each power class in FR2 bands.

FIG. 4 This figure illustrates exemplary values for Proposals A1-1 to A1-3 of Proposal A1 in an embodiment of the present disclosure.

FIG. 5 This figure illustrates Proposals A1-1 to A1-3 of Proposal A1 in an embodiment of the present disclosure by expressions.

FIG. 6 This figure illustrates an exemplary hardware configuration of the base station and the terminal.

### DESCRIPTION OF EMBODIMENT

The present disclosure is provided to address the above-described challenge. Hereinafter, an aspect of the present disclosure will be described in detail with reference to the accompanying drawings.

### Configuration of Radio Communication System

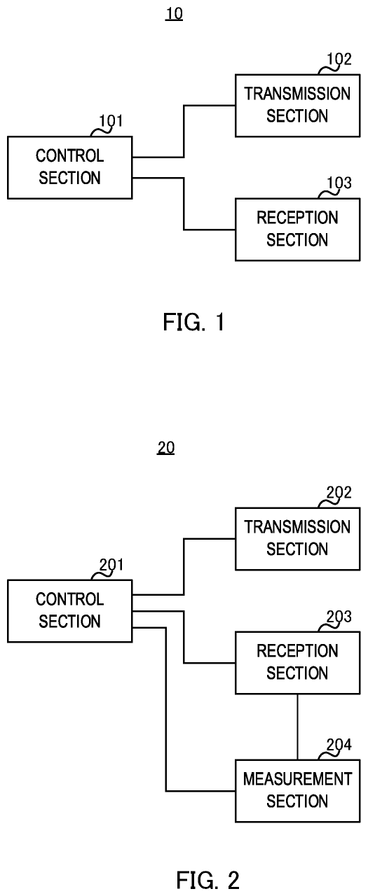

A radio communication system according to the present embodiment includes base station 10 (see FIG. 1) and terminal 20 (see FIG. 2). Base station 10 transmits a DL signal to terminal 20. In addition, base station 10 receives a UL signal transmitted from terminal 20. Terminal 20 receives a DL signal transmitted from base station 10 and transmits a UL signal to base station 10.

### Configuration of Base Station 10

FIG. 1 is a block diagram illustrating an exemplary configuration of base station 10 according to the present embodiment. Base station 10 includes, for example, control section 101, transmission section 102, and reception section 103.

Control section 101 controls transmission processing in transmission section 102 and reception processing in reception section 103.

For example, control section 101 performs scheduling (e.g., resource allocation) of a DL data signal to be transmitted by a PDSCH and a DL control signal to be transmitted by a PDCCH. Control section 101 also performs scheduling of a synchronization signal (primary synchronization signal (PSS)/secondary synchronization signal (SSS)) and a DL reference signal such as CRS, CSI-RS, and the like.

In addition, control section 101 performs scheduling of a UL data signal to be transmitted by a PUSCH and a UL control signal to be transmitted by a PUCCH, a random access preamble to be transmitted by a PRACH, and a UL reference signal.

Further, control section 101, for example, selects a cell to which terminal 20 is connected based on an RRM report that is included in a UL signal and indicates a reception quality measurement result.

Transmission section 102 transmits, to terminal 20, a signal (DL signal) addressed to terminal 20 under the control of control section 101.

The DL signal includes, for example, DL data (sometimes referred to as a PDSCH signal, for example), DL control information (sometimes referred to as a PDCCH signal, for example; PDCCH includes downlink control information (DCI)), a reference signal, etc. The DL control information includes, for example, an RA message (sometimes referred to as random access response (RAR) or message 2, for example) including a timing advance (TA) command, information indicating UL resource configuration (scheduling indication), network signaling (NS), etc.

The DL control information may be indicated to terminal 20 by higher layer signaling or may be indicated to terminal 20 by dynamic signaling such as DCI, for example. The higher layer signaling is sometimes referred to as radio resource control (RRC) signaling or a higher layer parameter, for example.

Reception section 103 receives a signal (UL signal) transmitted from terminal 20 under the control of control section 101.

The UL signal includes, for example, UL data (sometimes referred to as a PUSCH signal, for example), UL control information (sometimes referred to as a PUCCH signal, for example), a reference signal (e.g., SRS), an RA signal, etc. The UL control information includes, for example, an RRM report, etc.

### Configuration of Terminal 20

FIG. 2 is a block diagram illustrating an exemplary configuration of terminal 20 according to the present embodiment. Terminal 20 includes, for example, control section 201, transmission section 202, reception section 203, and measurement section 204.

Control section 201 controls transmission processing in transmission section 202 and reception processing in reception section 203.

For example, control section 201 may generate capability information indicating the capability of terminal 20 and transmit it from transmission section 202 to base station 10. In addition, control section 201 may control the UL signal transmit power so as to meet the specification of the power class of terminal 20. Control section 201 may also generate an RRM report based on a measurement result of measurement section 204 and transmit it from transmission section 202 to base station 10.

Transmission section 202 transmits a UL signal to base station 10 under the control of control section 201.

Reception section 203 receives a DL signal transmitted from base station 10 under the control of control section 201.

Measurement section 204 measures reception quality of a signal received by reception section 203 and outputs the measurement result to control section 203. To indicate the reception quality, received power of a reception signal (e.g., reference signal received power (RSRP)), reception signal strength (e.g., received signal strength indicator (RSSI)), reception quality (e.g., reference signal received quality (RSRQ), etc. are used.

### Radiated Power Specification Value in Inter-band CA

Next, methods of determining radiated power specification values in inter-band CA in FR2 will be described.

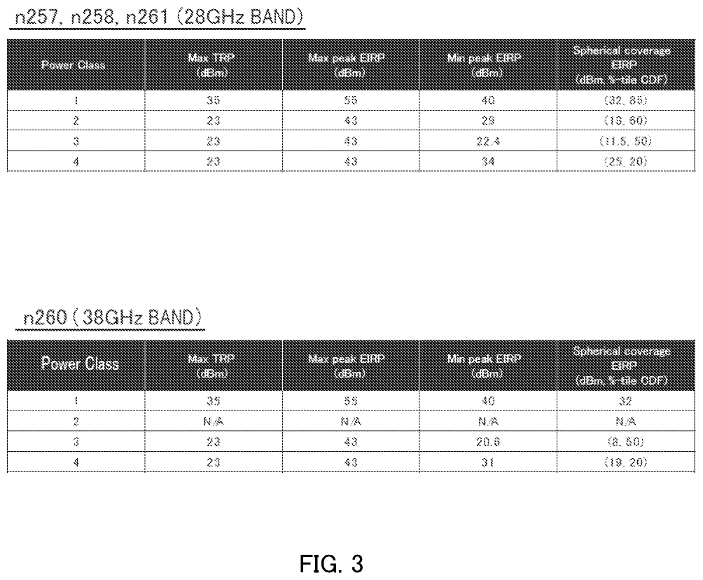

FIG. 3 illustrates radiated power specification values of items for each power class in FR2 bands described in NPL 1. At present, four power classes (PC1 to PC4) are specified in each of the 28 GHz band and 38 GHz band in FR2 as illustrated in FIG. 3. The radiated power specification values are determined for four items of the max TRP, max peak EIRP, min peak EIRP, spherical coverage EIRP in each power class. For example, the specification value of the max TRP of PC1 in the 28 GHz is “35 dBm”.

The existing radiated power specification values, however, do not assume the case where radio waves are radiated simultaneously in a plurality of directions in the inter-band CA in FR2, as described above.

In this regard, the present inventors propose introducing new radiated power specification values in the inter-band CA in FR2 on the basis of the existing specification for the power classes in FR2.

In the following, methods of determining the specification value of the max peak EIRP will be proposed with an example of performing the inter-band CA using two frequency bands of the 28 GHz band (first band) and the 38 GHz band (second band).

<Proposal 1>

According to Proposal 1, the EIRP in the 28 GHz band and the EIRP in the 38 GHz band are measured at a measurement point in each beam direction using a testing device, the total power of the EIRP in the 28 GHz band and the EIRP in the 38 GHz band at the measurement point in each beam direction is calculated, and the maximum value of the total power is determined as the specification value of the max peak EIRP. That is, in Proposal 1, the beam in the 28 GHz band and the beam in the 38 GHz band are configured in the same direction, and the specification value of the max peak EIRP is determined based on the total power of the EIRP in each direction.

This proposal makes it possible to guarantee the total power limit of each beam in the same direction. It is thus possible to guarantee not to exceed the maximum EIRP limit specified in the legal provision of each country. It is also possible to guarantee not to exceed the maximum EIRP limit in a case where the maximum EIRP limit is required in a specific area (e.g., hospital). In addition, since this determines only the total power in each beam direction, there is flexibility in allocation of the EIRP. Thus, one of the beams can be intentionally adjusted to a higher power to improve the connectivity depending on the distance to a base station to be connected to.

<Proposal 2>

According to Proposal 2, the EIRP in the 28 GHz band and the EIRP in the 38 GHz band are measured at a measurement point in each beam direction using a testing device, and the total power of the maximum EIRP in the 28 GHz band and the maximum EIRP in the 38 GHz band is determined as the specification value of the max peak EIRP. That is, in Proposal 2, the EIRP in the 28 GHz band and the EIRP in the 38 GHz band are each measured at a measurement point in each beam direction, and the specification value of the max peak EIRP is determined based on the total power of the maximum value of the EIRP in each frequency band regardless of the beam direction.

This proposal does not depend on the beam direction and eliminates the need for obtaining the total power of the EIRP in the same direction, thereby simplifying the terminal implementation and reducing the development cost. In addition, although it does not depend on the beam direction, the specification value of the max peak EIRP is determined based on the total power, and thus it is possible to guarantee the total power limit of each beam as in Proposal 1.

<Proposal 3>

According to Proposal 3, the EIRP in the 28 GHz band and the EIRP in the 38 GHz band are measured at a measurement point in each beam direction using a testing device, and the maximum EIRP in the 28 GHz band and the maximum EIRP in the 38 GHz band are independently determined as the specification values of the max peak EIRP. That is, in Proposal 3, the specification value of the max peak EIRP is determined based on the maximum value of the EIRP in each frequency band regardless of the beam direction.

This proposal is based on the maximum value of the EIRP in each frequency band regardless of the beam direction, and this allows the terminal to perform independent RF control in each frequency band in terms of EIRP control, thereby further simplifying the terminal implementation and reducing the development cost compared with Proposal 2. In addition, since the EIRP is determined independently rather than the total power, the minimum EIRP allocation that should be guaranteed can be guaranteed.

<Proposal 4>

According to Proposal 4, the EIRP in the 28 GHz band and the EIRP in the 38 GHz band are measured at a measurement point in each beam direction using a testing device, the total power of the EIRP in the 28 GHz band and the EIRP in the 38 GHz band at the measurement point in each beam direction is calculated, the maximum value of the total power is determined as the specification value of the max peak EIRP, and further, the EIRP in the 28 GHz band and the EIRP in the 38 GHz band in a beam direction with maximum total power are also determined as the specification values of the max peak EIRP. That is, in Proposal 4, the beam in the 28 GHz band and the beam in the 38 GHz band are configured in the same direction, and the specification values of the max peak EIRP are determined based on the total power of the EIRP in each direction and the individual EIRP in a beam direction with maximum total power in each frequency band.

This proposal makes it possible to guarantee the total power limit of each beam as in Proposal 1. In addition, since the EIRP is determined independently, the minimum EIRP allocation that should be guaranteed can be guaranteed as in Proposal 3.

Note that, in a test of radiating a plurality of beams, the EIRP may be measured by performing time-division transmission in bands composing the inter-band CA. For example, the time division duplex (TDD) scheme is used in the FR2 band, and thus, the UL configuration of the TDD configuration may be divided and used in each frequency band to measure the EIRP. The above testing method is particularly useful in a testing environment for millimeter-wave communication, which is over the air (OTA), because a plurality of frequencies are mixed in the environment and it is possibly difficult to measure a plurality of beams simultaneously radiated from the terminal due to influence waves, noise, etc. Unlike a conducted (wired) testing environment used in Sub6 RF testing, in which an RF port of the terminal is wired to a measurement device, the OTA testing environment is a measurement system in which a test is conducted by radiating radio waves into a real space.

Note that the min peak EIRP and max peak EIRP represent the minimum and maximum values of the peak EIRP, i.e., a range of values considered as the peak EIRP, as follows:
Min peak EIRP ≤Peak EIRP ≤Max peak EIRP.

Since the above proposals 1 to 4 are peak EIRP determining methods, for the min peak EIRP, it should be confirmed whether the peak EIRP is equal to or greater than the min peak EIRP after measuring the peak EIRP at which EIRP is maximized

[Effect]

As described above, the present embodiment makes it possible to determine the radiated power specification values in the inter-band CA in FR2 taking into account the case where radio waves are simultaneously radiated in a plurality of directions.

[Variations]

<Variation A>

Variation A is about proposals for the method of determining the specification value of the max TRP in the case where the radiated power specification value is independently determined for each frequency band, as described in the above Proposal 3 or Proposal 4.

<Proposal A1 >

In Proposal A1, the specification value of the max TRP is determined so that the total power of the max TRP in the inter-band CA is the same as the value for single carrier transmission. For example, the max TRP of PC3 at the time of CA between the 28 GHz band and 38 GHz band is 23 dBm (see FIG. 3). Further, in Proposal A1, the method of determining the specification value of the min peak EIRP, for example, will be described below.

<Proposal A1-1>

In Proposal A1-1, the specification value of the min peak EIRP is determined assuming the same TRP in the 28 GHz band and 38 GHz band. In addition, the specification value of the spherical coverage EIRP is determined accordingly.

<Proposal A1-2>

In Proposal A1-2, the same specification value of the min peak EIRP is determined for the 28 GHz band and 38 GHz band. In addition, the specification value of the spherical coverage EIRP is determined accordingly. Having the same min peak EIRP enhances the CA connectivity.

<Proposal A1-3>

In Proposal A1-3, the specification value of the min peak EIRP is determined so that the min peak EIRP in the 38 GHz band is higher than the min peak EIRP in the 28 GHz band. In addition, the specification value of the spherical coverage EIRP is determined accordingly. Propagation loss in the 38 GHz band is greater than that in the 28 GHz band (approximate difference of 2.6 dB for the same distance), and thus increasing the min peak EIRP in the 38 GHz band enhances the CA connectivity.

Note that, in Proposals A1-2 and A1-3, the specification value may be similarly determined based on the spherical coverage EIRP instead of the min peak EIRP.

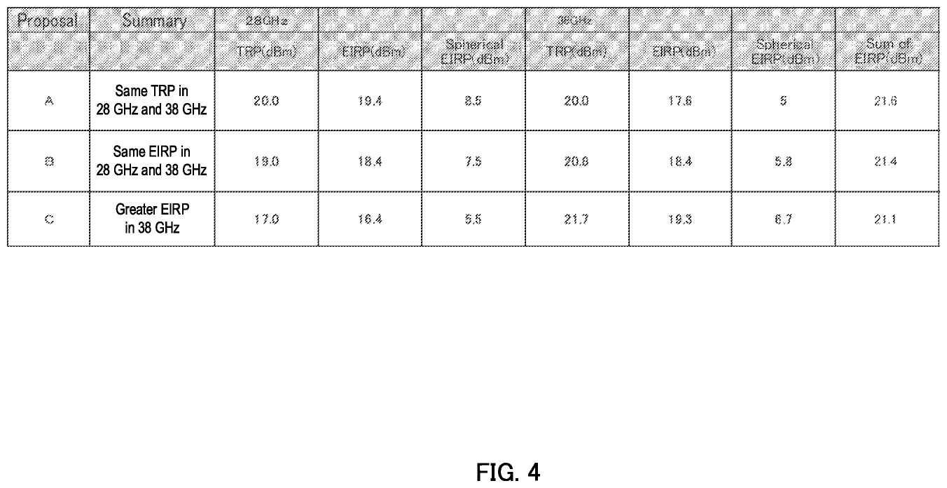

FIG. 4 illustrates exemplary values for Proposals A1-1 to A1-3 of Proposal A1.

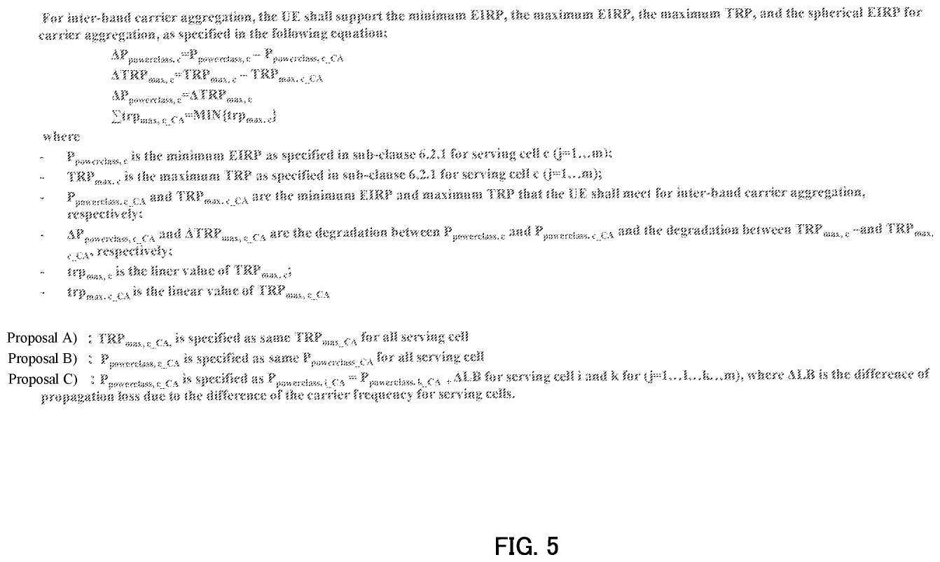

FIG. 5 illustrates Proposals A1-1 to A1-3 of Proposal A1 by expressions.

<Proposal A2>

In Proposal A2, the specification value of the max TRP is determined so that the total power of the max TRP in the inter-band CA is the sum of respective values for single carrier transmission. For example, the total power of the max TRP of PC3 in the inter-band CA between the 28 GHz band and 38 GHz band is 26 dBm. In this case, the EIRP allocation for each frequency band corresponds to the specification value for the single carrier. For example, in the inter-band CA of the 28 GHz band and 38 GHz band, the specification values of the max TRP are 22.4 dBm and 20.6 dBm respectively.

<Proposal A3>

In Proposal A3, the specification value of the max TRP in the inter-band CA is independently determined for each frequency band.

Note that, in Proposal A3, the upper limit may be specified for the total TRP power in each frequency band, and then the specification value of the max TRP may be independently determined for each frequency band. For example, it is assumed that the max TRP in the inter-band CA in the 28 GHz band is 23 dBm, and the max TRP in the inter-band CA in the 38 GHz band is 23 dBm.

In Proposal A1 and Proposal A2, the upper limit may be specified for the specification value of the max TRP in each frequency band, and then the total power of the max TRP may be calculated. For example, the total power of the max TRP in the inter-band CA between the 28 GHz band and 38 GHz band is 26 dBm.

<Variation B>

The methods of determining the radiated power specification value have been described above, taking the case of performing the inter-band CA using two separate frequency bands of the 28 GHz band and 38 GHz band. This proposal can also be applied to a case of performing the inter-band CA using operating bands belonging to the same frequency band (28 GHz band or 38 GHz band) or using two partially overlapping operating bands.

Variation B is about proposals for the method for determining the specification value of the max peak EIRP and the specification value of the max TRP taking into account a relation between operating bands of two CCs composing the inter-band CA.

<Proposal B1>

In 3GPP, n257, n258, and n261 are specified as the operating bands belonging to the 28 GHz band, and n259 and n260 are specified as the operating bands belonging to the 38 GHz band, as described above.

In Proposal B1, a method of determining the specification value of the max peak EIRP and the specification value of the max TRP is different between the case where the operating bands of two CCs composing the inter-band CA belong to the same frequency band and the case where they belong to different frequency bands. For example, in the case where the operating bands of two CCs belong to different frequency bands, such as a case of n260 and n261, the specification value of the max peak EIRP (e.g., 43 dBm) and the specification value of the max TRP (e.g., 23 dBm) are independently determined in the operating band of each CC. In addition, in the case where the operating bands of two CCs belong to the same frequency band, such as a case of n259 and n260, the total power of the maximum values of the EIRP in the operating bands of respective CCs is determined as the specification value of the max peak EIRP, and the total power of the maximum values of the TRP in the operating bands of respective CCs is determined as the specification value of the max TRP.

Upper limits of the max peak EIRP and the max TRP are configured by taking into account the effect of interference on neighboring systems using nearby frequencies as one factor. Thus, in the case where the operating bands of two CCs composing the inter-band CA belong to the same frequency band, it is preferable to determine the specification values of the max peak EIRP and the max TRP by the total power of these items. Meanwhile, in the case where the operating bands of two CCs belong to different frequency bands, the specification values of these items may be determined independently.

<Proposal B2>

In Proposal B2, a method of determining the specification value of the max peak EIRP and the specification value of the max TRP is different between the case where the operating bands of two CCs composing the inter-band CA overlap with each other and the case where they are separated from each other. For example, in the case where the operating bands of two CCs are separated from each other, the specification value of the max peak EIRP and the specification value of the max TRP are independently determined in the operating band of each CC. In addition, in the case where the operating bands of two CCs overlap with each other, the total power of the maximum values of the EIRP in the operating bands of respective CCs is determined as the specification value of the max peak EIRP, and the total power of the maximum values of the TRP in the operating bands of respective CCs is determined as the specification value of the max TRP.

Note that the case where “operating bands of two CCs overlap with each other” includes a case where the operating bands of two CCs are exactly the same, and a case where the upper end frequency of the operating band with the lower center frequency is higher than the lower end frequency of the operating band with the higher center frequency. Meanwhile, the case where “operating bands of two CCs are separated from each other” includes a case where the upper end frequency of the operating band with the lower center frequency is equal to or lower than the lower end frequency of the operating band with the higher center frequency.

<Proposal B3>

In Proposal B3, a method of determining the specification value of the max peak EIRP and the specification value of the max TRP is configured based on other signaling associated with the inter-band CA. The “other signaling” includes, for example, the capability information indicating whether beams between CCs composing the inter-band CA are controlled independently or integrally.

[Effect of Variation B]

As described above, Variation B makes it possible to determine the radiated power specification values in the inter-band CA in FR2 taking into account the relation between operating bands of two CCs.

Note that the above-described proposals may be applied as a regulation for terminals performing multi-beam radiation in single carrier transmission.

The above-described proposals may also be applied to a regulation of peak effective isotropic sensitivity (EIS), peak reference sensitivity, or EIS spherical coverage in inter-band DL CA.

An embodiment of the present disclosure has been described, thus far.

Note that, the block diagrams used to describe the above embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or wirelessly), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmission section,” “transmitting unit,” or “transmitter.” The methods for implementing the functions are not limited specifically as described above.

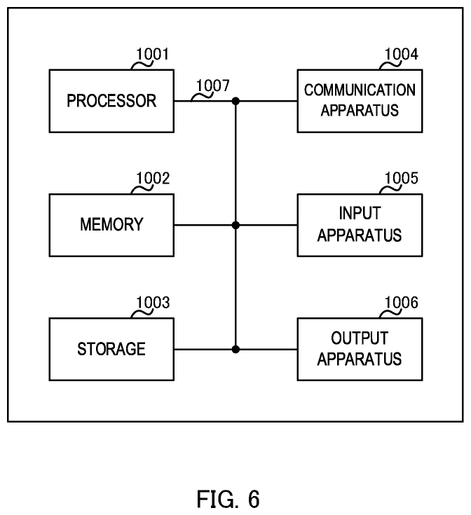

For example, a base station, a user terminal, and the like according to an embodiment of the present disclosure may function as a computer that executes processing of a wireless communication method of the present disclosure. FIG. 6 illustrates an exemplary hardware configuration of base station 10 and terminal 20 according to one embodiment of the present disclosure. Physically, base station 10 and terminal 20 as described above may be a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of base station 10 and of terminal 20 may include one apparatus or a plurality of apparatuses illustrated in the drawings or may not include part of the apparatuses.

The functions of base station 10 and terminal 20 are implemented by predetermined software (program) loaded into hardware, such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control sections 101 and 201 and the like as described above may be implemented using processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiment is used. For example, control sections 101 and 201 of base station 10 and terminal 20 may be implemented using a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to an embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and wireless networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission sections 102 and 202, reception sections 103 and 203, measurement section 204, and the like as described above may be implemented using communication apparatus 1004.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) that makes outputs to the outside. Note that input apparatus 1005 and output apparatus 1006 may be integrated (for example, a touch panel).

The apparatuses, such as processor 1001, memory 1002, and the like are connected by bus 1007 for communication of information. Bus 1007 may be configured using a single bus or using buses different between each pair of the apparatuses.

Furthermore, base station 10 and terminal 20 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

(Notification of Information and Signaling)

The notification of information is not limited to the aspect/embodiment described in the present disclosure, and the information may be notified by another method. For example, the notification of information may be performed out by one or a combination of physical layer signaling (for example, Downlink Control Information (DCI) and Uplink Control Information (UCI)), upper layer signaling (for example, Radio Resource Control (RRC) signaling, Medium Access Control (MAC) signaling, notification information (Master Information Block (MIB), and System Information Block (SIB))), and other signals. The RRC signaling may be called an RRC message and may be, for example, an RRC connection setup message, an RRC connection reconfiguration message, or the like.

(Adaptation System)

The aspect/embodiment described in the present specification may be applied to at least one of systems using Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

(Processing Procedure and the like)

The orders of the processing procedures, the sequences, the flow charts, and the like of the aspect and embodiment described in the present disclosure may be changed as long as there is no contradiction. For example, elements of various steps are presented in exemplary orders in the methods described in the present disclosure, and the methods are not limited to the presented specific orders.

(Operation of Base Station)

Specific operations which are described in the present disclosure as being performed by the base station may sometimes be performed by an upper node depending on the situation. Various operations performed for communication with a user terminal in a network constituted by one network node or a plurality of network nodes including a base station can be obviously performed by at least one of the base station and a network node other than the base station (examples include, but not limited to, MME or S-GW). Although there is one network node in addition to the base station in the case illustrated above, a plurality of other network nodes may be combined (for example, MME and S-GW).

(Direction of Input and Output)

The information and signals can be output from a higher layer (or a lower layer) to a lower layer (or a higher layer). The information, the signals, and the like may be input and output through a plurality of network nodes.

(Handling of Input and Output Information and the like)

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

(Determination Method)

The determination may be made based on a value expressed by one bit (0 or 1), based on a Boolean value (true or false), or based on comparison with a numerical value (for example, comparison with a predetermined value).

(Software)

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

(Information and Signals)

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

(“System” and “Network”)

The terms “system” and “network” used in the present disclosure can be interchangeably used.

(Names of Parameters and Channels)

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (for example, PUCCH and PDCCH) and information elements, can be identified by any suitable names, and various names assigned to these various channels and information elements are not limitative in any respect.

(Base Station)

The terms “Base Station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably in the present disclosure. The base station may be called a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

(Terminal)

The terms “Mobile Station (MS)”, “user terminal”, “User Equipment (UE)”, and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

(Base Station/Mobile Station)

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user terminal. For example, the aspect/embodiment of the present disclosure may find application in a configuration that results from replacing communication between the base station and the user terminal with communication between multiple user terminals (such communication may, for example, be referred to as device-to-device (D2D), vehicle-to-everything (V2X), or the like). In this case, user terminal 20 may be configured to have the functions that base station 10 described above has. The wordings “uplink” and “downlink” may be replaced with a corresponding wording for inter-equipment communication (for example, “side”). For example, an uplink channel, a downlink channel, and the like may be replaced with a side channel.

Similarly, the user terminal in the present disclosure may be replaced with the base station. In this case, base station 10 is configured to have the functions that user terminal 20 described above has.

(Meaning and Interpretation of Terms)

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming”, “expecting”, “considering”, and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

The reference signal can also be abbreviated as an RS and may also be called as a pilot depending on the applied standard.

The description “based on” used in the present disclosure does not mean “based only on”, unless otherwise specified. In other words, the description “based on” means both of “based only on” and “based at least on”.

Any reference to elements by using the terms “first”, “second”, and the like used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

The “section” in the configuration of each apparatus may be replaced with “means”, “circuit”, “device”, or the like.

In a case where terms “include”, “including”, and their modifications are used in the present disclosure, these terms are intended to be inclusive like the term “comprising”. Further, the term “or” used in the present disclosure is not intended to be an exclusive “or”.

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are used in each user terminal) on the basis of TTI to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the time domain of the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell”, “carrier”, and the like in the present disclosure may be replaced with “BWP”.

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

In a case where articles, such as “a”, “an”, and “the” in English, for example, are added in the present disclosure by translation, nouns following these articles may have the same meaning as used in the plural.

(Variations and the like of Aspects)

The aspect and embodiment described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiment described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### INDUSTRIAL APPLICABILITY

An exemplary embodiment of the present disclosure is useful for radio communication systems.

### REFERENCE SIGNS LIST

10 Base station
20 Terminal
101, 201 Control section
102, 202 Transmission section
103, 203 Reception section
204 Measurement section

1.-6. (canceled)

7. A terminal, comprising:
a control section that generates Capability information including a Power Class of the terminal; and
a transmission section that transmits the Capability information, wherein
Max TRP (Total Radiated Power) and Max EIRP (Equivalent Isotropic Radiated Power) are specified for each of the Power Classes, and
in at least one of the Power Classes, each of a specified value of Max EIRP for a first band and a specified value of Max EIRP for a second band is defined separately in Inter-band CA (Carrier Aggregation) using two bands.

8. The terminal according to claim 7, wherein
in at least one of the Power Classes, each of a specified value of Max TRP for the first band and a specified value of Max TRP for the second band is defined separately in the Inter-band CA.

9. A system, comprising:
a terminal that generates Capability information including a Power Class of the terminal, and transmits the Capability information; and
a base station that receives the Capability information, wherein
Max TRP (Total Radiated Power) and Max EIRP (Equivalent Isotropic Radiated Power) are specified for each of the Power Classes, and
in at least one of the Power Classes, each of a specified value of Max EIRP for a first band and a specified value of Max EIRP for a second band is defined separately in Inter-band CA (Carrier Aggregation) using two bands.

10. A communication method, comprising steps performed by a terminal of:
generating Capability information including a Power Class of the terminal; and
transmitting the Capability information, wherein
Max TRP (Total Radiated Power) and Max EIRP (Equivalent Isotropic Radiated Power) are specified for each of the Power Classes, and
in at least one of the Power Classes, each of a specified value of Max EIRP for a first band and a specified value of Max EIRP for a second band is defined separately in Inter-band CA (Carrier Aggregation) using two bands.
